(19) United States
(12) Patent Application Publication
(10) Pub. No.: US 2026/0106794 A1
(43) Pub. Date: Apr. 16, 2026

(54) Edge Enabler Layer Service Differentiation

(71) Applicant: TELEFONAKTIEBOLAGET LM ERICSSON (PUBL), Stockholm (SE)

(72) Inventor: Wenliang Xu, Shanghai (CN)

(21) Appl. No.: 19/116,855

(22) PCT Filed: Sep. 5, 2023
(86) PCT No.: PCT/CN2023/117026

§ 371 Date: Mar. 28, 2025

(30) Foreign Application Priority Data
Sep. 29, 2022 (WO) PCTCN2022122742

(51) Int. Cl. H04L 41/0806

(52) U.S. Cl. CPC H04L 41/0806

(57) ABSTRACT

The embodiments herein relate to edge enabler layer service differentiation. In some embodiments, there proposes a method (300) performed by a User Equipment (UE) (101) implementing an enabler function. In an embodiment, the method (300) may comprise the step of transmitting (S301), to an Edge Configuration Server (ECS), a first message for requesting service provisioning, wherein the first message includes one or more Edge Enabler Server (EES) provider identifiers identifying one or more desired EES providers. In an embodiment, the method (300) may further comprise the step of receiving (S302), from the ECS, a second message indicating one or more EESs (121). With the embodiments herein, the EDGE-4 reference point interactions may be optimized.

### CROSS REFERENCE TO RELATED APPLICATION

This application claims priority of PCT Application Serial Number PCT/CN2022/122742 filed on Sep. 29, 2022 with title of “EDGE ENABLER LAYER SERVICE DIFFERENTIATION”, the entire contents of which are incorporated herein by reference.

### TECHNICAL FIELD

The embodiments herein relate generally to the field of edge computing, and more particularly, the embodiments herein relate to Edge Enabler Layer (EEL) service differentiation.

### BACKGROUND

Edge computing is a concept that enables services to be hosted close to the service consumers and provides benefits such as efficient service delivery with significant reduction in end-to-end latency and decreased load on the transport network. The benefits of edge computing will strengthen the promise of 5G and expand the prospects for several new and enhanced use cases, including virtual and augmented reality, Internet of Things (IoT), industrial IoT, autonomous driving, real-time multiplayer gaming etc.

In Release 17, 3GPP aims to provide native support of edge computing in 3GPP networks. These efforts include initiatives across several working groups in 3GPP including SA6, SA2, SA3, SA4 and SA5, which cover application layer architecture, core network enhancement, security, media processing, and management aspects respectively.

SA6 initiated normative specification work on the architecture for enabling Edge Applications (EDGEAPP). The objective of the work is to define an enabling layer to facilitate communication between the Application Clients (AC) running on the User Equipment (UE) and the Edge Application Servers (EAS) deployed on the Edge Data Network (EDN). This includes aspects of service provisioning and EAS discovery. In addition, the work aims to provide supporting services such as application context transfer between EASs for service continuity, service enablement and capability exposure Application Programming Interfaces (APIs) towards the EAS.

FIG. 1 is a schematic block diagram showing example architecture of a wireless communication system 100 for enabling edge applications. As shown in FIG. 1, the functional entities may include:

Edge Enabler Server (EES): the EES 121 may provide supporting functions needed for the EASs 121 and the Edge Enabler Client (EEC) 111, e.g., EEC registration, EAS discovery and network APIs for EAS and service continuity support.

Edge Enabler Client (EEC): the EEC 111 may provide supporting functions needed for the AC(s) 112, e.g., retrieval and provisioning of configuration information to enable application data traffic, and EAS discovery.

Edge Configuration Server (ECS): the ECS 103 may provide supporting functions needed for the EEC 111 to connect with an EES 121, e.g., provisioning of edge configuration information to the EEC 111, and EES discovery.

Application Client (AC): the AC 112 is the application resident in the UE 101 performing the client function.

Edge Application Server (EAS): the EAS 122 is the application server resident in the EDN 102, performing the server functions. The AC 112 may connect to the EAS 122 in order to avail the services of the application with the benefits of edge computing.

There are several unsolved issues when discussing the next release, for example Release 18.

### SUMMARY

The embodiments herein propose methods, UE, network functions, computer readable medium and computer program product for edge enabler layer service differentiation.

In some embodiments, there proposes a method performed by a UE implementing an enabler function. The method may comprise the step of transmitting, to an ECS, a first message for requesting service provisioning. The first message may include one or more EES provider identifiers identifying one or more desired EES providers. The method may further comprise the step of receiving, from the ECS, a second message indicating one or more EESs.

In an embodiment, the one or more EESs may be configured with edge subscription data for the UE.

In an embodiment, the one or more EESs may be provided by at least one of the one or more desired EES providers identified by the one or more EES provider identifiers.

In an embodiment, the one or more EESs may be determined based on the one or more EES provider identifiers.

In an embodiment, the one or more EES provider identifiers may correspond to a list of desired EES provider identifiers and the list may include at least one desired EES provider identifier.

In an embodiment, the one or more EES may be indicated by one or more endpoints of the respective one or more EESs.

In an embodiment, the method may further comprise the step of selecting an EES from the one or more EESs, for providing differential service for the UE according to configured edge subscription data for the UE.

In an embodiment, the edge subscription data may be stored in the selected EES.

In an embodiment, the edge subscription data may include a UE ID of the UE.

In an embodiment, the edge subscription data may include at least one of an edge service level or a service policy.

In an embodiment, the first message may be a service provisioning request message over EDGE-4 reference point.

In an embodiment, the second message may be a service provisioning response message over EDGE-4 reference point.

In an embodiment, the first message may be a service provisioning subscription request message over EDGE-4 reference point.

In an embodiment, the second message may be a service provisioning notification message over EDGE-4 reference point.

In some embodiments, there proposes a method performed by an ECS. The method may comprise the step of receiving, from a UE implementing an enabler function, a first message for requesting service provisioning. The first message may include one or more EES provider identifiers identifying one or more desired EES providers. The method may further comprise the step of transmitting, to the UE, a second message indicating one or more EESs considering the one or more EES provider identifiers included in the first message.

In an embodiment, the indicated one or more EESs may be configured with edge subscription data for the UE.

In an embodiment, the one or more EESs may be provided by at least one of the one or more EES providers identified by the one or more EES provider identifiers.

In an embodiment, the one or more EES provider identifiers may correspond to a list of desired EES provider identifiers and the list may include at least one desired EES provider identifier.

In an embodiment, the one or more EESs may be indicated by one or more endpoints of the respective one or more EESs.

In an embodiment, the first message may be a service provisioning request message over EDGE-4 reference point.

In an embodiment, the second message may be a service provisioning response message over EDGE-4 reference point.

In an embodiment, the first message may be a service provisioning subscription request message over EDGE-4 reference point.

In an embodiment, the second message may be a service provisioning notification message over EDGE-4 reference point.

In some embodiments, there proposes a UE, comprising: at least one processor; and a non-transitory computer readable medium coupled to the at least one processor. In an embodiment, the non-transitory computer readable medium may store instructions executable by the at least one processor, whereby the at least one processor may be configured to perform the above methods related to the above UE.

In some embodiments, there proposes a network function, comprising: at least one processor; and a non-transitory computer readable medium coupled to the at least one processor. In an embodiment, the non-transitory computer readable medium may store instructions executable by the at least one processor, whereby the at least one processor may be configured to perform the above methods related to the above ECS. In an embodiment, the network function may be configured as the above ECS.

In some embodiments, there proposes a computer readable medium storing computer readable code, which when run on an apparatus, causes the apparatus to perform any of the above methods.

In some embodiments, there proposes a computer program product storing computer readable code, which when run on an apparatus, causes the apparatus to perform any of the above methods.

With the embodiments herein, the EEC may provide the desired EES service provider(s) to the ECS, and thus may narrow down the number of EES candidates in service provisioning response (i.e., un-wanted EES(s) may be filtered out by the ECS). As a result, the EDGE-4 reference point interactions between the EEC and the ECS may be optimized.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing example architecture of a wireless communication system for enabling edge applications;

FIG. 2A is a schematic signaling chart showing the messages in a service provisioning request-response procedure, according to the embodiments herein;

FIG. 2B is a schematic signaling chart showing the messages in a service provisioning subscription-notification procedure, according to the embodiments herein;

FIG. 3 is a schematic flow chart showing an example method in the UE, according to the embodiments herein;

FIG. 4 is a schematic flow chart showing an example method in the first network function, according to the embodiments herein;

FIG. 5 is a schematic block diagram showing an example UE, according to the embodiments herein;

FIG. 6 is a schematic block diagram showing an example network function, according to the embodiments herein; and

FIG. 7 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

There are several unsolved issues when discussing the next release, for example Release 18. Key issue (KI #12) (EEL service differentiation) says:

“The service differentiation in Rel-17 is very general and not detailed (e.g. ECS use local policy to determine service provisioning). Details to enable an ECSP to provide different service quality levels should be specified. Such as a principle based on the role of service consumer. For example, a premium user must get the nearest available edge, or there should be certain applications available only to the premium users and so on.

Open issues:
What service differentiation should be enabled by the EEL?
Which procedure should be enhanced to support service differentiation?
Which functional entity is responsible for defining or managing the service differentiation?”.

Currently, solution #12 in 3GPP TR 23.700-98 focuses on the service continuity planning authorization aspect based on UE policy configured in the EES and there is no solution to address aspect related to advanced edge computing service for premium user and how to discover an EES configured with such UE policy.

In view of the above key issue, the embodiments propose a solution to discover proper EES configured with UE policy (as part of edge subscription data).

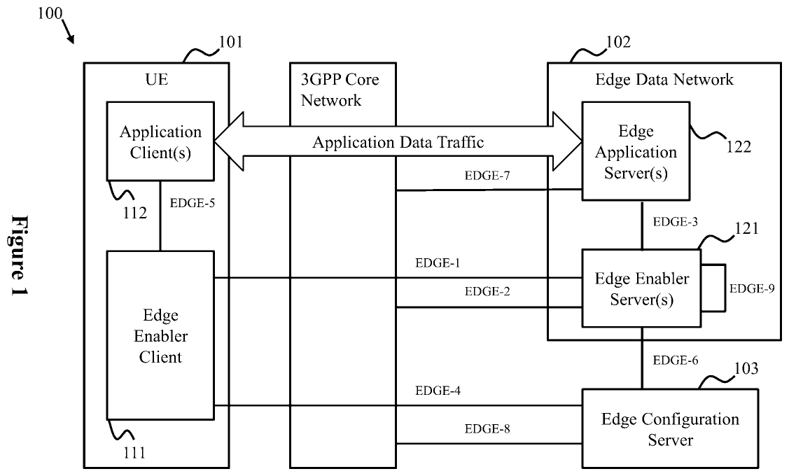

The embodiments may be implemented in the wireless communication system 100 as shown in FIG. 1.

In an embodiment, the wireless communication system 100 may be configured in an OTT scenario. The OTT connection may be transparent in the sense that the participating communication devices through which the OTT connection passes are unaware of routing of uplink and downlink communications. For example, a base station may not or needs not be informed about the past routing of an incoming downlink communication with data originating from the ECS 103, the EES(s) 121, or the EAS(s) 122 to be forwarded (e.g., handed over) to a connected UE 101. Similarly, the base station needs not be aware of the future routing of an outgoing uplink communication originating from the UE 101 towards the ECS 103, the EES 121(s), or the EAS 122(s).

It should also be understood that, a network function can be implemented either as a network element on a dedicated hardware, as a software instance running on a dedicated hardware, or as a virtualized function instantiated on an appropriate platform, e.g., on a cloud infrastructure.

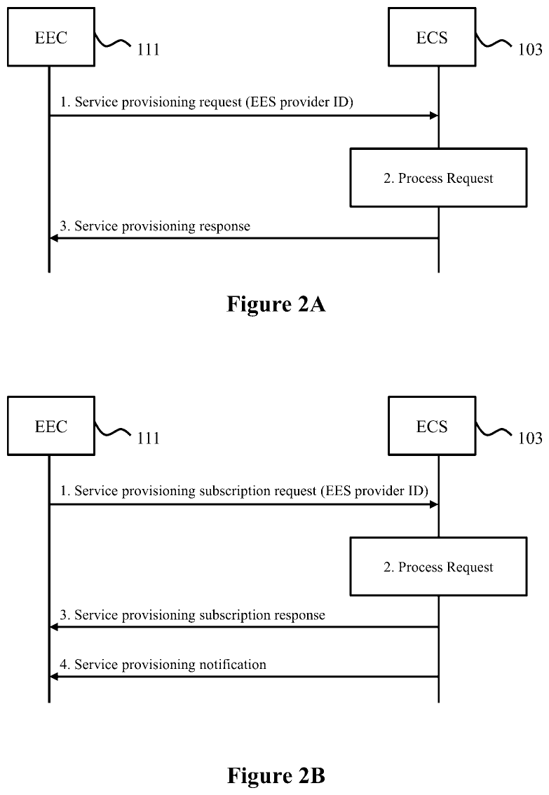

FIG. 2A is a schematic signaling chart showing the messages in a service provisioning request-response procedure, according to the embodiments herein.

In an embodiment, the messages in the service provisioning request-response procedure of FIG. 2A may be transmitted over EDGE-4 reference point, which enables interactions between the ECS 103 and the EEC 111. The EDGE-4 reference point supports: a) provisioning of edge configuration information to the EEC 111.

In an embodiment, the signaling chart in FIG. 2A may include the following messages or steps:

Step 1: The EEC 111 may send a service provisioning request to the ECS 103. The service provisioning request may include the UE identifier such as Generic Public Subscription Identifier (GPSI), connectivity information, UE location and AC profile(s) information.

In an embodiment, the EEC 111 may provide its desired EES service provider(s) (e.g., Edge Computing Service Provider(s), ECSP(s)) to the ECS 103. With such information, the ECS 103 may be able to provision the EEC 111 with the EES(s) 121 based on EES registered provider information.

In an embodiment, the EEC 111 may obtain the preferred EES provider ID by end user configuration. For example, Alice has signed VIP contract with Amazon edge computing service, then she may configure the EEC 111 in the UE 101 with “preferred EES provider=Amazon”; or this may be done by Amazon server via Short Messaging Service (SMS), device triggering, etc.

In an embodiment, the EEC 111 may be configured with more than one preferred EES providers. For example, the EEC 111 (as a special application client for edge computing) may have subscriptions with multiple EES providers (e.g. Amazon, Google, AT&T). This is like the daily life, a person can be VIP of multiple shopping malls; and when the person wants to know the exact civic address of preferred shopping malls, a query can be done towards a web service (e.g. Google Map).

In an embodiment, the EEC 111 may determine the EES provider(s) to be used in the service provisioning request. For example, if the EEC 111 has multiple preferred EES providers (e.g. Amazon, Google, AT&T), the EEC 111 may decide to use one or more of the preferred EES providers. Normally, the EEC 111 may include all preferred EES providers in service provisioning request and may obtain a list of EES(s) corresponding to all of the preferred EES providers. However, it is also possible that the end user may apply conditions, for example Amazon is preferred in working days and Google is preferred in calendar days. All of those determinations are internal behavior in the EEC 111.

The following Table 1 describes information elements for the service provisioning request sent from the EEC 111 to the ECS 103.

TABLE 1
service provisioning request

| Information element | Status | Description |
|---|---|---|
| EECID | M | Unique identifier of the EEC. |
| Security credentials | M | Security credentials resulting from a successful |
| | | authorization for the edge computing service. |
| AC Profile(s) | O | Information about services the EEC wants to connect to, |
| | | as described in Table 8.2.2-1 of 3GPP TS 23.558. |
| EEC Service | O | Indicates if the EEC supports service continuity or not. |
| Continuity Support | | The IE also indicates which ACR scenarios are supported |
| | | by the EEC. |
| UE Identifier | O | The identifier of the UE (i.e. GPSI or identity token) |
| Connectivity | O | List of connectivity information for the UE, e.g. PLMN |
| information | | ID, SSID. |
| UE location | O | The location information of the UE. The UE location is |
| | | described in clause 7.3.2 of 3GPP TS 23.558. |
| EES provider | O | The list of desired EES provider IDs. |
| identifiers | | |

As may be seen from Table 1, the EEC 111 may include one or more EES provider identifiers as a parameter in the service provisioning request message. The one or more EES provider identifiers may indicate a list of preferred EES providers.

Step 2: Upon receiving the request, the ECS 103 may perform an authorization check to verify whether the EEC 111 has authorization to perform the operation. The ECS 103 may also determine other information that needs to be provisioned, e.g. identification of the EDN, EDN service area, EES endpoint(s). In an embodiment, the ECS 103 may determine the EES endpoint(s) to be provided to the EEC 111 by considering the one or more EES provider identifiers, in addition to other filters. For example, the ECS 103 may determine, from the EESs hosted by the ECS 103, the EES(s) provided by EES service provider(s) holding valid edge subscription data for the UE, based on EES registered provider information.

Step 3: If the processing of the request was successful, the ECS 103 may respond to the request of the EEC 111 with a service provisioning response. For example, the ECS 103 may include the endpoint(s) of the EES(s) determined in the step 2 into the service provisioning response message. The EEC 111 may cache the service provisioning information (e.g. EES endpoint) for subsequent use and avoid the need to repeat step 1. In an embodiment, the EEC 111 may receive only the EES(s) that correspond to the EES provider ID sent in step 1.

In addition, the ECS 103 may reject the service provisioning request and respond with an appropriate failure cause.

In an embodiment, upon received the service provisioning information (e.g. EES endpoint(s)), the EEC 111 may select an EES 121 from the received EES information. The selected EES 121 may host or retrieve the edge subscription data for a UE, and thus may provide differential service for the UE 101.

For example, the EES 121, after receiving EAS discovery request from the EEC 111, may obtain the edge subscription data for the UE 101. Then the EES 121 may act differently when provisioning EAS candidates to the service consumer (e.g., the EEC 111) based on edge subscription data for the UE 101.

The following Table 2 describes information elements for the edge subscription data for the UE 101.

TABLE 2
edge subscription data for a UE

| Data | Description |
|---|---|
| UE ID | Identifies a UE, which is an EES specific UE ID |
| Edge service level | Identifies the service level, e.g. free, paid (e.g. VIP) |
| Service policies | Detailed edge service policies under the service level, such as |
| | assured edge service during EAS discovery, temporal condition, |
| | spatial condition |

In an example, the service policy may be the maximum number of applications for edge computing. For example, the EES 121 may only support maximum 5 applications for a free UE. In an example, the service policy may be temporal and spatial conditions for providing edge service, such as EAS discovery under different edge service levels.

FIG. 2B is a schematic signaling chart showing the messages in a service provisioning subscription-notification procedure, according to the embodiments herein.

In an embodiment, the messages in the service provisioning subscription-notification procedure of FIG. 2B may be transmitted over EDGE-4 reference point, which enables interactions between the ECS 103 and the EEC 111. The EDGE-4 reference point supports: a) provisioning of edge configuration information to the EEC 111.

In an embodiment, the signaling chart in FIG. 2B may include the following messages or steps:

Step 1: The EEC 111 may send a service provisioning subscription request to the ECS 103. The service provisioning subscription request may include Notification Target Address (e.g. URL) and may include the UE identifier such as GPSI, connectivity information, proposed expiration time and AC profile information.

In an embodiment, the EEC 111 may provide its desired EES service provider(s) (e.g., ECSP(s)) to the ECS 103. With such information, the ECS 103 may be able to provision the EEC 111 with the EES(s) 121 based on EES registered provider information.

In an embodiment, the service provisioning subscription request may include one or more of the information elements as shown in the above Table 1. For example, the EEC 111 may include one or more EES provider identifiers as a parameter in the service provisioning subscription request message. The one or more EES provider identifiers may indicate a list of preferred EES providers.

Step 2: Upon receiving the request, the ECS 103 may perform an authorization check to verify whether the EEC 111 has authorization to perform the operation. If the request is authorized, the ECS 103 may create and store the subscription for provisioning.

Step 3: If the processing of the request was successful, the ECS 103 may respond with a service provisioning subscription response.

In addition, the ECS 103 may reject the service provisioning subscription request and respond with an appropriate failure cause.

Step 4: An event occurs at the ECS 103 that satisfies trigger conditions for updating service provisioning of a subscribed EEC 111. The ECS 103 may determine information that needs to be provisioned, e.g. identification of the EDN, EDN service area, EES endpoint(s). In an embodiment, the ECS 103 may determine the EES endpoint(s) to be provided to the EEC 111 by considering the one or more EES provider identifiers, in addition to other filters. For example, the ECS 103 may determine, from the EESs hosted by the ECS 103, the EES(s) provided by EES service provider(s) holding valid edge subscription data for the UE, based on EES registered provider information.

Then, the ECS 103 may send a provisioning notification to the EEC 111 with the information as determined. For example, the ECS 103 may include the endpoint(s) of the EES(s) determined in the step 2 in the service provisioning notification message. In an embodiment, the EEC 111 may receive only the EES(s) that correspond to the EES provider ID sent in step 1.

In an embodiment, upon received the service provisioning information (e.g. EES endpoint(s)), the EEC 111 may select an EES 121 from the received EES information. The selected EES 121 may host or retrieve the edge subscription data for a UE, and thus may provide differential service for the UE 101.

For example, the EES 121, after receiving EAS discovery request from the EEC 111, may obtain the edge subscription data for the UE 101. Then the EES 121 may act differently when provisioning EAS candidates to the service consumer (e.g., the EEC 111) based on edge subscription data (as shown in the above Table 2) for the UE 101.

As seen above, in some embodiments, the EEC 111 may indicate its preferred EES provider as part of the service provisioning request filter, and the ECS 103 may offer the EEC 111 with matched EES(s) based on registered EES information (i.e. EES provider).

With the embodiments herein, the EEC 111 may provide the desired EES service provider(s) to the ECS 103, and thus may narrow down the number of EES candidates in service provisioning response (un-wanted EES(s) may be filtered out by the ECS 103). As a result, the EDGE-4 reference point interactions between the EEC 111 and the ECS 103 may be optimized.

In addition, the embodiments may enable EEL service differentiation and thus may address KI #12. The EES 121 may be able to distinguish different UEs and apply different policies for the UEs based on subscription information. The ECS 103 may be able to identify the EES(s) 121 during service provisioning procedure based on EEC supplied EES provider identifier, so as to provide the correct EES having the corresponding edge subscription data for the UE 101.

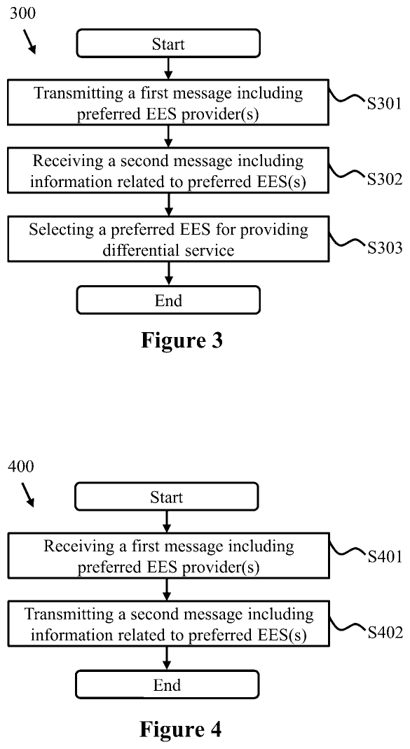

FIG. 3 is a schematic flow chart showing an example method 300 in the UE 101, according to the embodiments herein. In an embodiment, the flow chart in FIG. 3 may be implemented in the functional component implementing an enabler function (such as the EEC 111) in FIGS. 1, 2A and 2B.

The method 300 may begin with step S301, in which the functional component (such as the EEC 111) may transmit, to a first network function (such as the ECS 103) implementing an ECS, a first message for requesting service provisioning. The first message may include a first parameter indicating one or more edge service providers. That is, the UE 101 implementing the enable function may transmit to the ECS 103, the first message for requesting service provisioning.

In an embodiment, the first parameter may include one or more EES provider identifiers. In an embodiment, the one or more EES provider identifiers may indicate a list of preferred EES providers. That is, the first message may include one or more EES provider identifiers identifying the one or more desired (or preferred) EES providers. The one or more EES provider identifiers may correspond to a list of desired EES provider identifiers and the list may include at least one desired EES provider identifier as shown in Table 1.

In an embodiment, the first message may be a service provisioning request message over EDGE-4 reference point. In another embodiment, the first message may be a service provisioning subscription request message over EDGE-4 reference point.

Then, the method 300 may proceed to step S302, in which the functional component (such as the EEC 111) may receive, from the first network function (such as the ECS 103), a second message including a second parameter indicating one or more second network functions implementing EESs. That is, the UE 101 may receive the second message indicating the one or more EESs. Optionally, the one or more EESs are configured with edge subscription data for the UE 101. The one or more second network functions may be provided by at least one of the one or more edge service providers. In another word, the one or more EESs may be determined based on the one or more EES provider identifiers identifying the one or more edge service providers.

In an embodiment, the second parameter may include one or more endpoints of the respective one or more second network functions. That is, the one or more EESs may be indicated by endpoints of the respective one or more EESs.

In an embodiment, the second message may be a service provisioning response message over EDGE-4 reference point. In another embodiment, the second message may be a service provisioning notification message over EDGE-4 reference point.

Then, the method 300 may proceed to an optional step S303, in which the functional component (such as the EEC 111) may select a second network function from the one or more second network functions, for providing differential service for the UE 101 according to the edge subscription data.

In an embodiment, the edge subscription data may be stored in the selected second network function.

In an embodiment, the edge subscription data may include a UE ID of the UE.

In an embodiment, the edge subscription data may include at least one of an edge service level or a service policy.

The above steps are only examples, and the functional component may perform any related actions described with respect to FIGS. 1, 2A and 2B.

FIG. 4 is a schematic flow chart showing an example method 400 in the first network function, according to the embodiments herein. In an embodiment, the flow chart in FIG. 4 may be implemented in the ECS 103 in FIGS. 1, 2A and 2B.

The method 400 may begin with step S401, in which the first network function (such as the ECS 103) may receive, from a UE 101 including a functional component (such as the EEC 111) implementing an enabler function, a first message for requesting service provisioning. The first message may include a first parameter indicating one or more edge service providers, that is the EES providers. Optionally, as shown in Table 1, the first message may include one or more EESs provider identifiers identifying the one or more desired EES providers.

In an embodiment, the first parameter may include one or more EES provider identifiers. In an embodiment, the one or more EES provider identifiers may indicate a list of preferred EES providers. As shown in Table 1, the one or more EES provider identifiers may correspond to a list of desired EES provider identifiers and the list may include at least one desired EES provider identifier.

In an embodiment, the first message may be a service provisioning request message over EDGE-4 reference point. In another embodiment, the first message may be a service provisioning subscription request message over EDGE-4 reference point.

Then, the method 400 may proceed to step S402, in which the first network function (such as the ECS 103) may transmit, to the UE 101, a second message including a second parameter indicating one or more second network functions implementing EESs. As mentioned above, the ECS 103 may consider the one or more EES provider identifiers included in the first message when determining the one or more EESs and indicate the one or more EESs to the UE 101 in the second message. The one or more EESs may be configured with edge subscription data for the UE 101. The one or more second network functions may be provided by at least one of the one or more edge service providers identified by the desired EES provider identifiers in the first message.

In an embodiment, the second parameter may include one or more endpoints of the respective one or more second network functions. That is, the one or more EESs may be indicated by one or more endpoints of the respective one or more EESs.

In an embodiment, the second message may be a service provisioning response message over EDGE-4 reference point. In another embodiment, the second message may be a service provisioning notification message over EDGE-4 reference point.

The above steps are only examples, and the first network function may perform any related actions described with respect to FIGS. 1, 2A and 2B.

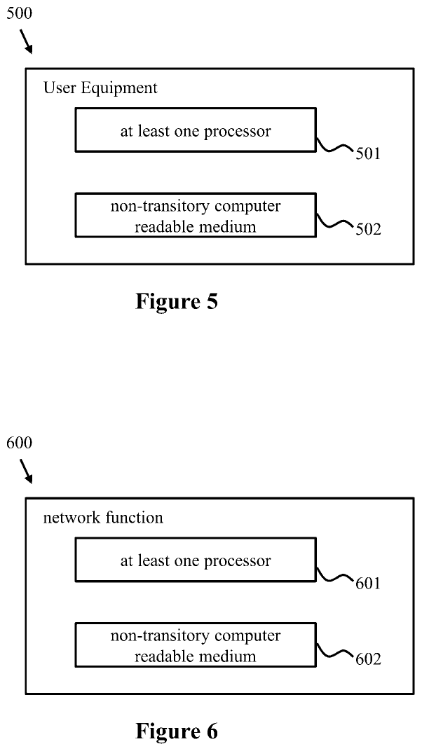

FIG. 5 is a schematic block diagram showing an example UE 500, according to the embodiments herein. In an embodiment, the example UE 500 in FIG. 5 may be implemented as the UE 101 in FIGS. 1, 2A and 2B.

In an embodiment, the UE 500 may include at least one processor 501; and a non-transitory computer readable medium 502 coupled to the at least one processor 501. The non-transitory computer readable medium 502 may store instructions executable by the at least one processor 501, whereby the at least one processor 501 may be configured to perform the steps in the example methods 300 as shown in the schematic flow charts of FIG. 3; the details thereof are omitted here.

Note that, the UE 500 may be implemented as hardware, software, firmware and any combination thereof. For example, the UE 500 may include a plurality of units, circuities, modules or the like, each of which may be used to perform one or more steps of the example method 300 or one or more steps shown in FIGS. 1, 2A and 2B related to the UE 101 and its functional component (such as the EEC 111 and/or the AC 112).

FIG. 6 is a schematic block diagram showing an example network function 600, according to the embodiments herein. In an embodiment, the example network function 600 in FIG. 6 may be implemented as the ECS 103 in FIGS. 1, 2A and 2B.

In an embodiment, the network function 600 may include at least one processor 601; and a non-transitory computer readable medium 602 coupled to the at least one processor 601. The non-transitory computer readable medium 602 may store instructions executable by the at least one processor 601, whereby the at least one processor 601 may be configured to perform the steps in the example method 400 as shown in the schematic flow charts of FIG. 4; the details thereof are omitted here.

Note that, the network function 600 may be implemented as hardware, software, firmware and any combination thereof. For example, the network function 600 may include a plurality of units, circuities, modules or the like, each of which may be used to perform one or more steps of the example method 400 or one or more steps shown in FIGS. 1, 2A and 2B related to the first network function (such as the ECS 103).

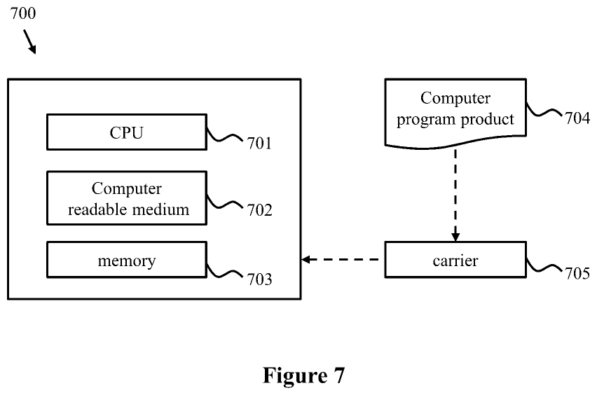

FIG. 7 is a schematic block diagram showing an example computer-implemented apparatus 700, according to the embodiments herein. In an embodiment, the apparatus 700 may be configured as the above mentioned apparatus, such as the UE 101 or its functional component (such as the EEC 111 and/or AC 112), the first network function (such as the ECS 103), or the second network function (such as the EES 121).

In an embodiment, the apparatus 700 may include but not limited to at least one processor such as Central Processing Unit (CPU) 701, a computer-readable medium 702, and a memory 703. The memory 703 may comprise a volatile (e.g., Random Access Memory, RAM) and/or non-volatile memory (e.g., a hard disk or flash memory). In an embodiment, the computer-readable medium 702 may be configured to store a computer program and/or instructions, which, when executed by the processor 701, may cause the processor 701 to carry out any of the above mentioned methods.

In an embodiment, the computer-readable medium 702 (such as non-transitory computer readable medium) may be stored in the memory 703. In another embodiment, the computer program may be stored in a remote location for example computer program product 704 (also may be embodied as computer-readable medium), and accessible by the processor 701 via for example carrier 705.

The computer-readable medium 702 and/or the computer program product 704 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Furthermore, the following amendments are proposed to amend the current 3GPP Technical Report 3GPP TR 23.700-98 V1.2.0 (2022 September).

### Title: EEL Service Differentiation

### Introduction

This contribution proposes a new solution to support EEL service differentiation.

### Reason for Change:

Following key issue has been agreed to study:

### 4.12 Key Issue #12: EEL Service Differentiation

The service differentiation in Rel-17 is very general and not detailed (e.g. ECS use local policy to determine service provisioning). Details to enable an ECSP to provide different service quality levels should be specified. Such as a principle based on the role of service consumer. For example, a premium user must get the nearest available edge, or there should be certain applications available only to the premium users and so on.

### Open Issues:

What service differentiation should be enabled by the EEL?
Which procedure should be enhanced to support service differentiation?
Which functional entity is responsible for defining or managing the service differentiation?

### Proposed Changes:

***1st Change*** (the proposed change includes the following the content to be added to the 3GPP TR 23.700-98 V1.2.0 (2022 September))

### 7.x Solution #X3: EES Policy Differentiation

### 7.x.1 Architecture Enhancements

None.

### 7.x.2 Solution Description

For edge service differentiation, the UE profile and policy can be managed by EES, table 7.x.2-1 gives an example for the information provisioned for a UE:

TABLE 7.x.2-1
Edge subscription data for a UE

| Data | Description |
|---|---|
| UE ID | Identifies a UE, which is an EES specific UE ID |
| Edge service level | Identifies the service level, e.g. free, paid (e.g. VIP) |
| Service policies | Detailed edge service policies under the service level, such as |
| | assured edge service during EAS discovery, temporal condition, |
| | spatial condition |

For instance, the EES, after receiving EAS discovery request, obtains the edge subscription data for the UE. Then the EES acts differently when provisioning EAS candidates to the service consumer (e.g. EEC) based on Edge subscription data for the UE. For instance, policy can be the max. number of applications for edge computing, e.g. EES can only support max. 5 applications for a free UE. Another example is temporal and spatial conditions for providing edge service like EAS discovery under different Edge service levels. More detailed Edge subscription data is implementation specific in EES and out of the scope of the study.

Since this is a contract subscription with EES providers and ECS may host multiple EESs provided by different ECSPs, the EEC needs to contact the EES(s) which is provided by EES service provider(s) holding valid Edge subscription data for the UE. This requires the EEC to provide its desired EES service provider(s) in the service provisioning procedure as depicted in FIG. 2A. With such information, the ECS is able to provision the EEC with EES(s) based on EES registered provider information.

### FIG. 2A: Service Provisioning—Request/Response

Table 7.x.2-1 shows the additional impact for the information flow of the service provisioning request.

TABLE 7.x.2-1
Service provisioning request

| Information element | Status | Description |
|---|---|---|
| EECID | M | Unique identifier of the EEC. |
| Security credentials | M | Security credentials resulting from a successful |
| | | authorization for the edge computing service. |
| AC Profile(s) | O | Information about services the EEC wants to connect to, |
| | | as described in Table 8.2.2-1 of 3GPP TS 23.558. |
| EEC Service | O | Indicates if the EEC supports service continuity or not. |
| Continuity Support | | The IE also indicates which ACR scenarios are supported |
| | | by the EEC. |
| UE Identifier | O | The identifier of the UE (i.e. GPSI or identity token) |
| Connectivity | O | List of connectivity information for the UE, e.g. PLMN |
| information | | ID, SSID. |
| UE location | O | The location information of the UE. The UE location is |
| | | described in clause 7.3.2 of 3GPP TS 23.558. |
| EES provider | O | The list of desired EES provider IDs. |
| identifiers | | |

The EES provider identifier is also applicable for the subscribe-notify model of service provisioning procedure (i.e. included in the service provisioning subscription request).

### 7.x.3 Solution Evaluation

This solution addresses KI #12 which enables EEL service differentiation. The EES is able to distinguish different UEs and applies different policies for the UE based on subscription information. In order to address the correct EES having the corresponding Edge subscription data for the UE, the ECS is able to identify the EES(s) during service provisioning procedure based on EEC supplied EES provider identifier.

### ***End of Changes***

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

### Abbreviations

3GPP 3rd Generation Partnership Project
AC Application Client
API Application Programming Interface
EAS Edge Application Server
ECS Edge Configuration Server
ECSP Edge Computing Service Provider
EDGEAPP Architecture for Enabling Edge Applications
EDN Edge Data Network
EEC Edge Enabler Client
EEL Edge Enabler Layer
EES Edge Enabler Server
IoT Internet of Things
OTT Over The Top
SA Service and System Aspects
UE User Equipment.

1.-17. (canceled)

18. A method performed by a User Equipment (UE) implementing an enabler function, comprising:
transmitting, to an Edge Configuration Server (ECS), a first message for requesting service provisioning, wherein the first message includes one or more Edge Enabler Server (EES) provider identifiers identifying one or more desired EES providers; and
receiving, from the ECS, a second message indicating one or more EESs.

19. The method according to claim 18, wherein the one or more EESs are determined based on the one or more EES provider identifiers.

20. The method according to claim 18, wherein the one or more EES provider identifiers correspond to a list of desired EES provider identifiers and the list includes at least one desired EES provider identifier.

21. The method according to claim 18, wherein the one or more EESs are configured with edge subscription data for the UE.

22. The method according to claim 18, wherein the one or more EESs are indicated by one or more endpoints of the respective one or more EESs.

23. The method according to claim 18, further comprising selecting an EES from the one or more EESs for providing differential service for the UE according to configured edge subscription data for the UE.

24. The method according to claim 23, wherein the edge subscription data are stored in the selected EES, wherein the edge subscription data includes a UE ID of the UE, or wherein the edge subscription data includes at least one of an edge service level or a service policy.

25. The method according to claim 18, wherein:
the first message is a service provisioning request message over EDGE-4 reference point;
the second message is a service provisioning response message over EDGE-4 reference point;
the first message is a service provisioning subscription request message over EDGE-4 reference point; or
the second message is a service provisioning notification message over EDGE-4 reference point.

26. A method performed by an Edge Configuration Server (ECS), the method comprising:
receiving, from a User Equipment (UE) implementing an enabler function, a first message for requesting service provisioning, wherein the first message includes one or more Edge Enabler Server (EES) provider identifiers identifying one or more desired EES providers; and
transmitting, to the UE, a second message indicating one or more EESs considering the one or more EES provider identifiers included in the first message.

27. The method according to claim 26, wherein the one or more EES provider identifiers correspond to a list of desired EES provider identifiers and the list includes at least one desired EES provider identifier.

28. The method according to claim 26, wherein the one or more EESs are indicated by one or more endpoints of the respective one or more EESs.

29. The method according to claim 26, wherein the one or more EESs are configured with edge subscription data for the UE.

30. The method according to claim 26, wherein:
the first message is a service provisioning request message over EDGE-4 reference point;
the second message is a service provisioning response message over EDGE-4 reference point;
the first message is a service provisioning subscription request message over EDGE-4 reference point; or
the second message is a service provisioning notification message over EDGE-4 reference point.

31. A User Equipment (UE), comprising:
at least one processor; and
a non-transitory computer readable medium coupled to the at least one processor, the non-transitory computer readable medium contains instructions executable by the at least one processor, whereby the at least one processor is configured to:
transmit to an Edge Configuration Server (ECS), a first message for requesting service provisioning, wherein the first message includes one or more Edge Enabler Server (EES) provider identifiers identifying one or more desired EES providers; and
receive, from the ECS, a second message indicating one or more EESs.

32. The UE according to claim 31, wherein the one or more EESs are determined based on the one or more EES provider identifiers.

33. The UE according to claim 31, wherein the one or more EES provider identifiers correspond to a list of desired EES provider identifiers and the list includes at least one desired EES provider identifier.

34. The UE according to claim 31, wherein the one or more EESs are configured with edge subscription data for the UE.

35. The UE according to claim 31, wherein the one or more EESs are indicated by one or more endpoints of the respective one or more EESs.

36. The UE according to claim 31, the non-transitory computer readable medium containing instructions executable by the at least one processor, whereby the at least one processor is further configured to select an EES from the one or more EESs for providing differential service for the UE according to configured edge subscription data for the UE.

37. The UE according to claim 31, wherein the edge subscription data are stored in the selected EES, wherein the edge subscription data includes a UE ID of the UE, or wherein the edge subscription data includes at least one of an edge service level or a service policy.
